(19) United States
(12) Patent Application Publication
(10) Pub. No.: US 2020/0090096 A1
(43) Pub. Date: Mar. 19, 2020

(54) RESOURCE MANAGEMENT SYSTEM, MANAGEMENT DEVICE, METHOD, AND PROGRAM

(71) Applicant: NEC CORPORATION, Tokyo (JP)

(72) Inventor: Masaki INOKUCHI, Minato-ku, Tokyo (JP)

(73) Assignee: NEC CORPORATION, Tokyo (JP)

(21) Appl. No.: 16/616,597

(22) PCT Filed: May 30, 2017
(86) PCT No.: PCT/JP2017/020083

§ 371 Date: Nov. 25, 2019

(51) Int. Cl. G06Q 10/06; G06Q 30/02; G06Q 20/06; G06F 16/23

(52) U.S. Cl. CPC G06Q 10/06315; G06F 16/2315; G06Q 20/065; G06Q 30/0284

(57) ABSTRACT

A resource management system of the invention includes: one or more functional units 501 that provide a predetermined function as a service; a resource allocation unit 502 that allocates a resource for executing a service, to each of the functional units 501; and a points management unit 503 that, for each user and each of the functional units 501, manages the number of points held, said points being virtual currency required for receiving a service. Each of the functional units 501 provides a service for exchanging for each of the points held by the requesting user or other functional unit. The resource allocation unit 502 allocates the resource by reducing each of the points held by a functional unit that is the allocation destination.

### TECHNICAL FIELD

The present invention relates to a resource management system, a management device, a resource management method, and a resource management program for managing a resource to be allocated to one or more functional units that provide a predetermined function as service.

### BACKGROUND ART

A service providing side demands to continuously provide service to legitimate users even when a failure occurs or a malicious device exists. A service providing base that satisfies such demand is desired.

One of service providing architectures includes a micro service architecture (hereinafter referred to as an MSA). The MSA finely divides a monolithic software architecture into a group of functional units with a low degree of coupling, and causes the functional units to cooperate with each other to provide equivalent service. The MSA can independently handle the function required to provide service, and thus has advantages of rapid development and deployment, excellent resiliency, and scalability.

FIG. 21 is an explanatory diagram showing an example of a service providing program using a microservice. FIG. 21 shows an example of an architecture in which a front-end service receives a service request from a user and causes a microservice in a subsequent stage to appropriately perform processing, and then a service is provided to the user by the processing cooperation. Examples of the microservice include authentication service, access permission, data management (update, deletion, and extraction), and recommendation. The MSA is used as an architecture for providing service on a cloud.

Resource management in a service system for providing service by causing such a plurality of functional units to cooperate with each other will be considered below. FIG. 22 is an explanatory diagram showing an example of a resource management method in the MSA. In the MSA, for example, a management entity monitors the usage status of resources in each microservice, and when, for example, the resource usage rate of a microservice exceeds a standard, the management entity newly allocates a resource. When, for example, the resource usage rate of a microservice falls below the standard, the management entity releases resources. Here, the resource allocation may be to copy an instance of the corresponding microservice. The resource release may be to delete an instance of the corresponding microservice. The microservice itself may determine the resource usage status, and transmit a resource request to the management entity.

Patent Literature 1 describes a method of performing resource distribution control with dynamic adaptability in accordance with the congested state of resources on the basis of requests of individual users (host computers) in a dispersive environment.

### CITATION LIST

### Patent Literature

PTL 1: Japanese Patent Application Laid-Open No. Hei 11-66018

### SUMMARY OF INVENTION

### Technical Problem

The problem is that inappropriate resource allocation is performed when a malicious user or functional unit exists. In one example, the malicious user or functional unit requests a resource though not lacking a resource, and a management entity allocates a resource on the basis of the request. In order to prevent such a resource request, it is conceivable to perform the above-described monitoring.

Even when the monitoring is performed, however, if, for example, one functional unit repeatedly receives idle requests or the like accompanying no service provision, from the malicious user, a resource may be insufficient even in the situation without the reality of service provision. For example, when a certain functional unit is infected with a virus or the like, the functional unit can be made to seem to lack a resource for service provision by, for example, using a resource for another pieces of processing or the like even though the functional unit does not actually provide service. A management entity that detects such a situation may allocate an excessive resource.

If many resources are allocated to such a functional unit that does not accompany the reality of service provision, a resource to be allocated is unfortunately insufficient when, for example, other functional unit actually needs a resource for service provision.

In view of the above-described problems, an object of the invention is to provide a resource management system, a management device, a resource management method, and a resource management program which are capable of allocating a resource that matches the reality of service provision.

### Solution to Problem

A resource management system according to the invention includes: one or more functional units which provide a predetermined function as a service; a resource allocation unit which allocates a resource for executing a service, to each of the functional units; and a points management unit which, for each user and each of the functional units, manages the number of points held, said points being virtual currency required for receiving a service, in which each of the functional units provides a service for exchanging for each of the points held by the requesting user or other functional unit, and the resource allocation unit allocates the resource by reducing each of the points held by a functional unit that is the allocation destination.

A management device according to the invention includes: an information holding unit which holds points management information, with which the number of points held, said points being virtual currency required for receiving a service is capable of being grasped, for each user and each of one or more functional units that provide a predetermined function as a service; and a points updating unit which performs processing of moving each of the points from the requesting user or other functional unit to a functional unit of a request destination in accordance with provision of the service in each of the functional units and processing of reducing each of the points held by a functional unit that is the allocation destination in accordance with allocation of the resource to the functional unit by updating or editing the points management information held by the information holding unit.

A resource management method according to the invention is used in a resource management system including: one or more functional units which provide a predetermined function as a service; and a resource allocation unit which allocates a resource for executing a service, to each of the functional units, in which one or more information processing devices: for each user and each of the functional units, manage the number of points held, said points being virtual currency required for receiving a service; move each of the points from the requesting user or other functional unit to a functional unit of a request destination in accordance with provision of the service in the functional unit; and reduce each of the points held by a functional unit that is the allocation destination in accordance with allocation of the resource to the functional unit.

A resource management program according to the invention causes a computer to execute: for each user and each of one or more functional units that provide a predetermined function as a service, processing of managing the number of points held, said points being virtual currency required for receiving a service; processing of moving each of the points from the requesting user or other functional unit to a functional unit of a request destination in accordance with provision of the service in each of the functional units, and processing of reducing each of the points held by a functional unit that is the allocation destination in accordance with allocation of the resource to the functional unit.

### Advantageous Effects of Invention

According to the invention, resource allocation that matches the reality of service provision can be achieved.

### BRIEF DESCRIPTION OF DRAWINGS

FIG. 1 is an explanatory diagram outlining the invention.

FIG. 2 is an explanatory diagram showing a usage example of points.

FIG. 3 is a block diagram showing a configuration example of a resource management system of a first exemplary embodiment.

FIG. 4 is a block diagram showing another configuration example of the resource management system of the first exemplary embodiment.

FIG. 5 is an explanatory diagram showing an example of the data structure of a blockchain 41.

FIG. 6 is an explanatory diagram for explaining falsification resistance of the blockchain 41.

FIG. 7 is a block diagram showing an example of a ledger management node 42 provided in a ledger management system 4.

FIG. 8 is an explanatory diagram showing an example of management information.

FIG. 9 is a flowchart showing one example of operation of the resource management unit 3.

FIG. 10 is a flowchart showing an operation example of an entity (functional unit 1) of a service callee.

FIG. 11 is a flowchart showing an operation example of an entity on a service calling side.

FIG. 12 is a flowchart showing an operation example of the functional unit 1.

FIG. 13 is an explanatory diagram showing an example of a method of managing a blockchain.

FIG. 14 is an explanatory diagram outlining a second exemplary embodiment.

FIG. 15 is an explanatory diagram showing an example of timing of mining processing in the functional unit 1.

FIG. 16 is a block diagram showing a configuration example of a resource management system of the second exemplary embodiment.

FIG. 17 is an explanatory diagram outlining a third exemplary embodiment.

FIG. 18 is an explanatory diagram showing an example of idle time.

FIG. 19 is a schematic block diagram showing a configuration example of a computer according to the exemplary embodiment of the invention.

FIG. 20 is a block diagram outlining a resource management system of the invention.

FIG. 21 is an explanatory diagram showing an example of a service providing program using a microservice.

FIG. 22 is an explanatory diagram showing an example of a resource management method in an MSA.

### DESCRIPTION OF EMBODIMENTS

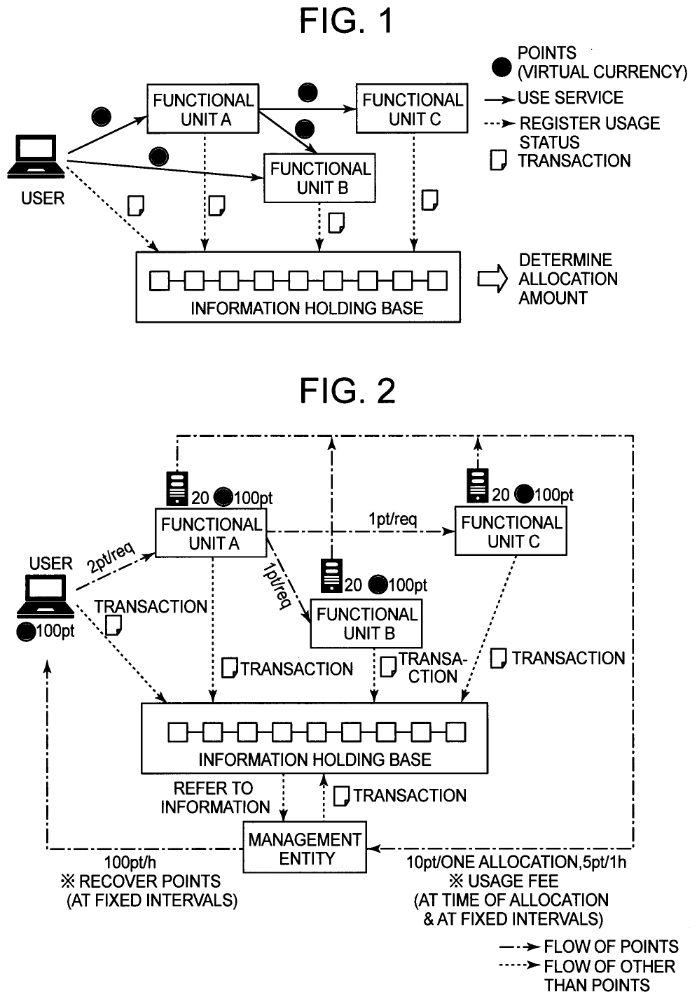

Exemplary embodiments of the invention will be described below with reference to the drawings. First, the concept of the invention will be briefly described. FIG. 1 is an explanatory diagram outlining the invention. The invention manages the service usage status in each functional unit by using points (virtual currency). A resource allocation amount to a functional unit is determined on the basis of the points.

More specifically, in order to manage the usage status of provided service in the functional unit, a certain number of points are given to a user in the invention. The user corresponds to an end point of service provision. Although the points may be given here to, for example, a terminal actually used by the user, the points may be given only on management data.

FIG. 2 is an explanatory diagram showing a usage example of points in the invention. As shown in FIG. 2, in the invention, the user pays points to a functional unit of a request destination each time the user uses service. Each functional unit also pays points to a functional unit of the usage destination each time the functional unit uses other functional unit. In this way, the reality of service provision is represented by the number of points paid to each functional unit. A resource is allocated to each functional unit by using points that increases or decreases each time such service is provided. For example, a management entity causes each functional unit to pay a resource usage fee with the points at the time of resource acquisition or periodically after the resource acquisition. If the resource usage fee cannot be paid, the management entity takes measures such as not allocating or taking away (releasing) a resource.

The management entity manages such movement of points by using one or more information holding base held by a system, together with usage information of service and allocation information of a resource. Although the information holding base is not particularly limited here as long as the information holding base is a base that can hold information, such as a storage and a database system, a blockchain, with which information can be shared among a plurality of devices, is more preferred.

### First Exemplary Embodiment

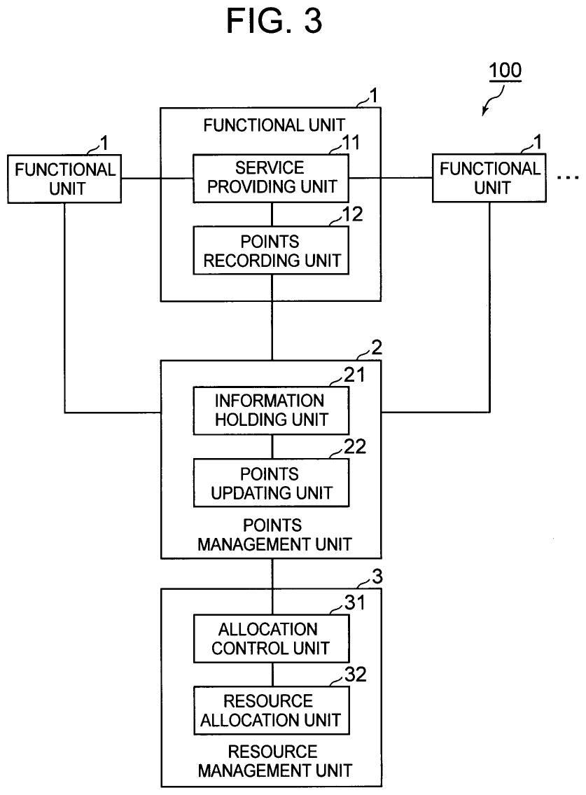

FIG. 3 is a block diagram showing a configuration example of a resource management system 100 of a first exemplary embodiment. The resource management system 100 in FIG. 3 includes a plurality of functional units 1, a points management unit 2, and a resource management unit 3.

The functional unit 1 is an independent unit that implements a predetermined function for providing service, such as the above-described microservice, and that provides the function in response to a request. Note that the functional unit 1 is not limited to an independent device, and may be a program that provides the function. That is, a plurality of functional units 1 may be implemented in one server or virtualization base. Even in such a case, each of the functional units 1 is regarded as an independent unit. In the invention, the function provided by the functional unit is also regarded as one service.

The functional unit 1 of the exemplary embodiment includes a service providing unit 11 and a points recording unit 12.

The service providing unit 11 provides a predetermined function in response to a request.

When a change occurs in points held by the points recording unit 12, for example, when receiving a request from a user or other functional unit or when giving a request to other functional unit, the points recording unit 12 notifies the later-described points management unit 2 of the change, and causes the points management unit 2 to record the change. At this time, the points recording unit 12 may give notification about not only the number of changed points but transaction details of points such as a payee, a payment source, and a payment target (e.g., service usage/resource usage).

The points recording unit 12 may detect change in points held by the points recording unit 12 itself (functional unit 1 including the points recording unit 12) by, for example, monitoring to the service providing unit 11 or notification from the service providing unit 11. If too many transactions are generated by notification that is given each time when a change occurs in held points, the points recording unit 12 may give notification about the change from the previous time at one time at fixed intervals or fixed number of times.

The points management unit 2 manages the number of held points for each entity including the user and the functional unit 1. For example, the points management unit 2 manages the number of points held by each entity by storing all the flow of the points in the system. The points management unit 2 may also manage a service usage condition in each functional unit, such as the number of points necessary for the system or each functional unit to use service.

The points management unit 2 recovers points for the user at fixed intervals in order to circulate points in the system. At this time, the points management unit 2 sets the recovered points not to exceed an upper limit of points that the user can hold. Initial points may be preliminarily given to the user and each of the functional units 1. For example, the initial points may be given when the user joins the system. Note that the processing unit for recovering user points and giving initial points is not particularly limited, and the resource management unit 3 or a separately provided user management unit (not shown) may perform these operations.

In order to manage the number of points held by each entity, the points management unit 2 may include, for example, an information holding unit 21 and a points updating unit 22. The information holding unit 21 holds information with which held points of each entity can be grasped. The points updating unit 22 moves or increases/decreases points by updating or editing the information, with which the held points can be grasped, held by the above-described information holding unit in response to a request from each entity or a predetermined condition.

The resource management unit 3 manages resources of the system, and performs control such as allocating a resource to each of the functional units 1 and releasing the allocated resource as necessary. As shown in FIG. 3, the resource management unit 3 includes an allocation control unit 31 and a resource allocation unit 32. Although FIG. 3 shows one resource management unit 3, a plurality of resource management units 3 may be provided.

The allocation control unit 31 determines a resource allocation amount for each of the functional units 1 on the basis of the monitoring result of the resource usage status of the functional unit 1 or a request. When a resource is allocated to the functional unit 1, the allocation control unit 31 also collects points in accordance with the allocation amount from the functional unit 1. If the allocation control unit 31 cannot collect the points in accordance with the allocation amount, the allocation control unit 31 may reject a request without allocating a new resource, or collect an allocated resource. In this way, the allocation control unit 31 provides a resource to the functional unit 1 by reducing the points accumulated in the functional unit 1 in accordance with the reality of service provision.

The resource allocation unit 32 allocates a resource to each functional unit on the basis of the allocation amount determined by the allocation control unit 31.

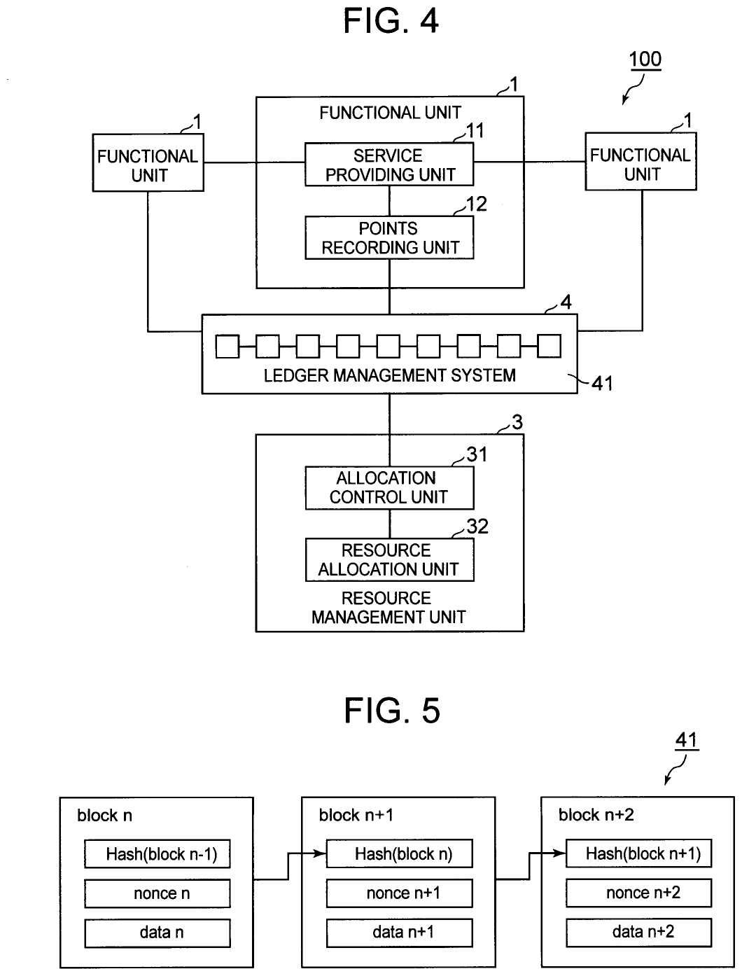

As shown in FIG. 4, the resource management system 100 may include a ledger management system 4 using a blockchain 41 as the points management unit 2. An example in which the points management unit 2 is the ledger management system 4 will be described below.

Generally, a blockchain enables dispersive information sharing without depending on a specific centralized management server. A blockchain that is difficult to falsify is shared between terminals by each terminal (later-described ledger management node 42) that participates in the blockchain performing processing (hereinafter referred to as consensus processing) that depends on predetermined consensus algorithm at the time of adding a block to the blockchain. Note that, although FIG. 4 shows one blockchain 41, the blockchain 41 is actually held in each of the ledger management nodes 42 included in the ledger management system 4.

FIG. 5 is an explanatory diagram showing an example of the data structure of the blockchain 41. As shown in FIG. 5, the blockchain 41 has a configuration of connection of data having predetermined data structure called a block. Each of the blocks contains a hash value (“Hash x” in the figure) of the previous block, nonce (“nonce x” in the figure), and data (“data x” in the figure) stored in the block. Here, “x” represents an identifier for identifying a block. For example, a block n includes the hash value of a block n−1, nonce n, and data n. Note that any data such as transaction information may be the data n.

The blockchain 41 that is difficult to falsify can be used for, for example, verifying information as a ledger by causing the blockchain 41 to hold data on, for example, transaction details, application information, and other pieces of information such as management information and authentication information.

Here, nonce is verification information that influences the falsification resistance of the blockchain 41. Specifically, the nonce plays a role as verification information set in the process of executing consensus algorithm called proof of work (PoW).

In PoW, processing (hereinafter simply referred to as processing of searching for nonce) of searching for a value to be set in a nonce region contained in certain data is performed on the data so that a value obtained when the data is processed by a unidirectional function satisfies a predetermined rule.

At this time, for example, a hash function can be used as the unidirectional function. The rule at that time can be set as “a hash value is equal to or less than a threshold (target value)”. Generally, the processing of searching for nonce cannot be efficiently performed due to the nature of unidirectional function. For this reason, a device for performing the processing actually repeats operation of setting an appropriate value for nonce and checking whether the rule is satisfied. Many nodes perform such an operation of setting and checking in parallel. The node that finds nonce satisfying the rule fastest transmits information to other nodes. All nodes then confirm the state of data containing a value of the nonce (consensus is gained) on the basis of the information.

A general flow of adding a block in the blockchain 41 will now be described. A block is added to the blockchain 41 by operations such as the following (1) to (5).

(1) A terminal that desires to record information in the blockchain 41 notifies any or all of terminals participating in the blockchain 41 of the information.

(2) Each terminal checks the consistency of the received information, and if there is no problem, generates a block.

(3) Each terminal starts PoW for the generated block.

(4) A terminal that has finished PoW notifies all terminals of the block in which the nonce found in the PoW is set.

(5) A terminal that has been notified of the block in which the nonce is set checks a hash value and the consistency of the information stored in the block, and if there is no problem, adds the block to the tail end of the blockchain 41 managed by the terminal itself.

Note that, in the above-described operation of (2), the method of checking the consistency of the received information depends on an application that uses the blockchain 41. When a block is generated, a plurality of pieces of information can be combined into one block.

In the above-described PoW operation of (3), each terminal further performs the following operations.

(3-1) Each terminal first sets a random nonce (nonce candidate) to the generated block.

(3-2) Each terminal checks whether the hash value of the block satisfies a predetermined rule (e.g., whether the hash value of the block is equal to or less than a certain target value).

(3-3) When the rule is satisfied, each terminal finishes the processing. When the rule is not satisfied, each terminal changes the set nonce and returns to (3-2).

Note that all terminals that have been notified of the information simultaneously perform the above-described PoW operation of (3) in parallel. The terminal that has finished PoW fastest is regarded as a terminal that has gained a right to add a block to the blockchain 41.

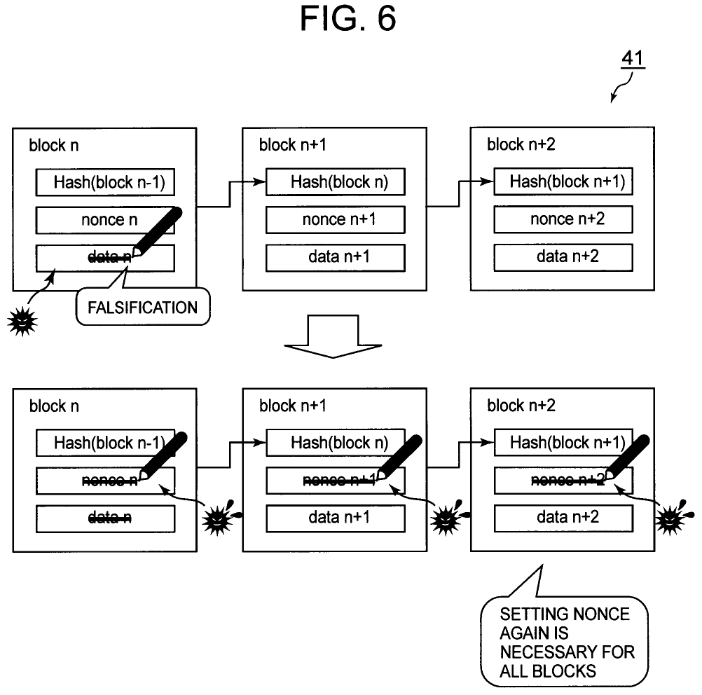

FIG. 6 is an explanatory diagram for explaining falsification resistance of the blockchain 41. As shown in FIG. 6, it is assumed that a certain terminal has falsified information (“data n” of “block n” in the figure) written in a past block. The falsification changes the hash value of the block. As a result, when the changed hash value exceeds a target value, the falsification is detected at any verification timing. In order to prevent detection of the falsification, the nonce (“nonce n” in the figure) of the block needs to be set again to a value equal to or less than the target value.

Since the fact remains that the hash value of the block changes, however, the hash value does not match “a hash value of the previous block” (“Hach (block n)” of “block n+1” in the figure) contained in the next block. For this reason, setting nonce again is necessary not only for the block but for all the subsequent blocks. Generally, it is said that an enormous amount of computation (equal to or more than 50% of the total amount of computation of a node that manages a blockchain) is required for falsification.

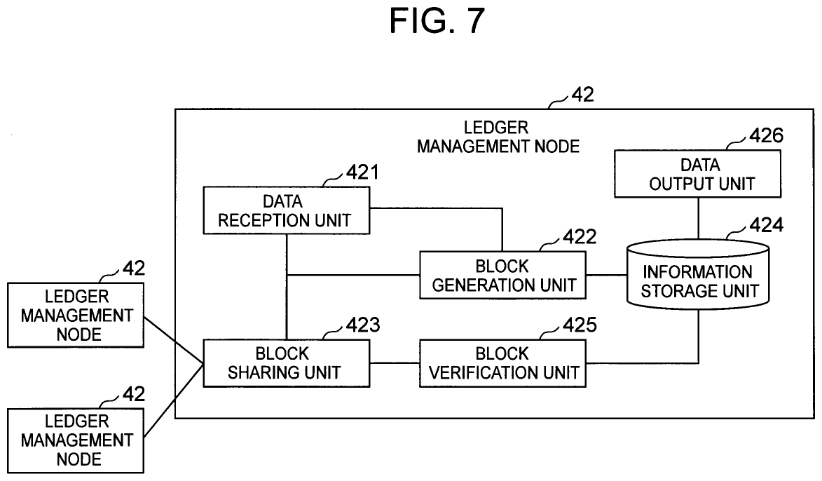

FIG. 7 is a block diagram showing an example of the ledger management node 42 provided in the ledger management system 4. The ledger management system 4 includes two or more ledger management nodes 42 (not shown). When a new block is added to a blockchain, each ledger management node performs predetermined consensus processing, and holds a copy of the blockchain 41. Note that consensus algorithm in the ledger management system 4 is not limited to PoW. For example, consensus algorithm such as byzantine fault tolerance (BFT) can also be used in addition to PoW.

The ledger management node 42 in FIG. 7 includes a data reception unit 421, a block generation unit 422, a block sharing unit 423, an information storage unit 424, a block verification unit 425, and a data output unit 426. Note that, in the case of the example, the information storage unit 424 corresponds to the above-described information holding unit 21, and the block generation unit 422 corresponds to the above-described points updating unit 22.

The data reception unit 421 receives information to be recorded in the blockchain 41 from an external node. In the exemplary embodiment, the data reception unit 421 receives, for example, the later-described service usage information, resource allocation information, and points payment information serving as the information to be stored in the blockchain 41.

The block generation unit 422 generates a block to be added to the blockchain by using the information received by the data reception unit 421. The block generation unit 422 generates a block including information (e.g., hash value) based on the previous block and information received by the data reception unit 421. The block generation unit 422 performs, for example, processing of searching for a nonce or processing of giving a signature on the block generated by the block generation unit 422 itself or the block generated by other ledger management node 42 via the later-described block sharing unit 423 as predetermined consensus processing, and adds the block to a blockchain (corresponding to a copy of the blockchain 41) managed by the block generation unit 422 itself. A block obtained by a plurality of ledger management node 42 performing predetermined consensus processing on the block generated by the block generation unit 422 is finally added to the blockchain 41. Processing, which includes consensus processing, for adding a block to a blockchain may be referred to as mining below.

The block sharing unit 423 exchanges information between the ledger management nodes 42 belonging to the ledger management system 4. More specifically, the block sharing unit 423 appropriately transmits, for example, information received by the data reception unit 421, a block generated by the block generation unit 422, and a block received from other ledger management node 42 to other ledger management node 42. As a result, all possible ledger management nodes 42 share these pieces of information and the latest blockchain 41.

The information storage unit 424 stores a copy of the blockchain 41. Note that the information storage unit 424 may store, for example, information necessary for verification processing at the later-described block verification unit 425 in addition to the copy of the blockchain 41.

The block verification unit 425 verifies a block when adding the block to the blockchain held by the block verification unit 425 itself. For example, the block verification unit 425 may verify whether a block to be added actually satisfies a rule, whether a node that has generated the block and a signature are matched, and whether information, based on the previous block, in the block to be added matches information generated from the actual previous block.

The data output unit 426 searches for and outputs a block containing desired information from the blockchain 41 held by the data output unit 426 itself in response to a request from an external node.

Note that the configuration in FIG. 7 is merely one example, and the ledger management node 42 can perform predetermined consensus processing for a plurality of nodes to share and manage the blockchain 41 that is difficult to falsify. Any specific configuration is possible as long as a node can add information to a ledger in response to a request from an external node and can refer to a ledger.

When the blockchain 41 is used, each user terminal and each functional unit operate as an entity using the blockchain 41. Typically, each entity has a pair of a secret key and a public key, adds a signature to transaction with the secret key, and transmits the transaction to a miner (e.g., the above-described ledger management node 42). Each miner adds the block to the blockchain on the basis of the transmitted transaction. Each entity can acquire miner information from other entities when participating in the system.

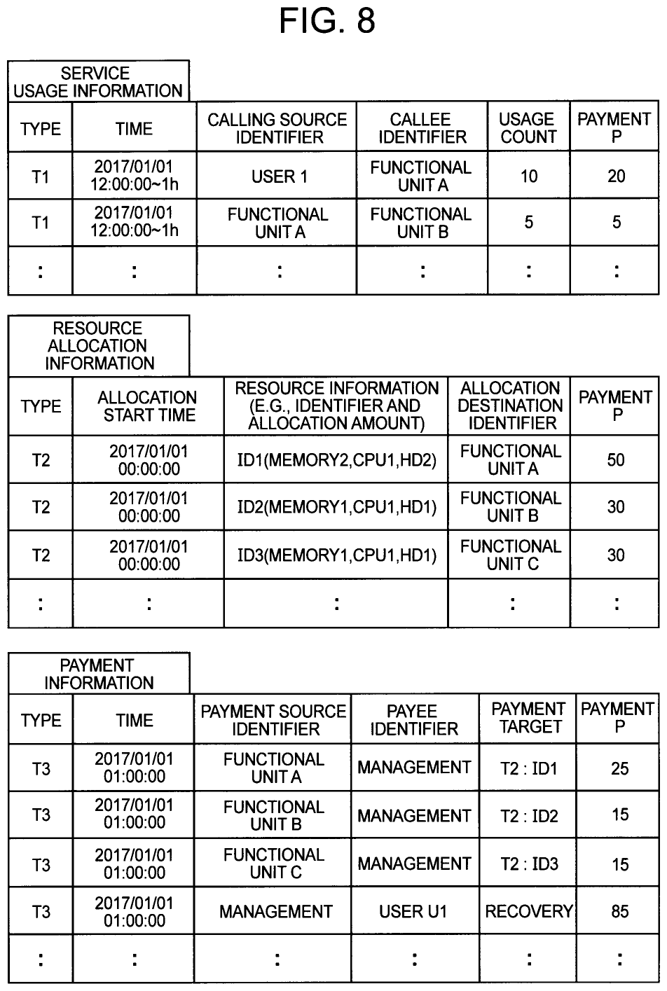

FIG. 8 is an explanatory diagram showing an example of points management information held by the points management unit 2 (blockchain 41 in the example). The points management unit 2 may store, for example, service usage information, resource allocation information, and payment information serving as points management information.

The service usage information indicates service usage status in each functional unit. The service usage information may include, for example, a transaction type, a time, a caller identifier, a callee identifier, a usage count, and payment points.

Here, the transaction type represents the type of transaction that has issued the record. For example, “T1” in the figure indicates that the record is a transaction of the service usage information. The transaction is issued by, for example, an entity that has called a service (caller entity). The time represents the time point or time zone when service has been used. The caller identifier represents an identifier of the entity that has called the service. The callee identifier represents an identifier of an entity whose service has been called. The usage count represents the number of times of service usage, by a combination of the reading source and the reading destination, performed at the time point or time zone indicated by time. Note that, when the service usage information is registered every service usage, the usage count can be omitted. The payment points represents the number of points paid for the service usage indicated by the record. More specifically, the number of points here is the total number of points paid by a reading source entity to a reading destination entity at the time point or time zone indicated by the time of the record.

The resource allocation information indicates resource allocation status to each functional unit. The resource allocation information may include, for example, a transaction type, an allocation start time, resource information, an allocation destination identifier, and payment points.

The transaction type represents the type of transaction that has issued the record. For example, “T2” in the figure indicates that the record is a transaction of the resource allocation information. The transaction is issued by, for example, an entity (resource management unit 3) that has performed resource allocation. The allocation start time represents the time when resource allocation is started. The resource information represents details of the allocated resource. Here, the resource information preferably includes information (e.g., identifier) that can specify the allocated resource and the amount of the allocated resource. The allocation destination identifier is an identifier of an entity (more specifically, a functional unit) of resource allocation destination. The payment points represents the number of points paid by resource allocation indicated by the record. More specifically, the number of points here is the total number of points paid by the allocation destination entity at the time when the resource is allocated to the entity at the time indicated by the record.

The payment information indicates fee for periodic resource usage and status, such as points recovery for a user, of points payment that does not accompany service usage. The payment information may include, for example, a transaction type, a time, a payment source identifier, a payee identifier, a payment target, and payment points.

The transaction type represents the type of transaction that has issued the record. For example, “T3” in the figure indicates that the record is a transaction of the payment information. The time represents the time point when points indicated by the record is paid. The payment source identifier represents an identifier of the payment source entity of the points indicated by the record. The payee identifier represents an identifier of a payee entity of the points indicated by the record. The payment target represents the target (reason for payment) for which points indicated by the record is paid. For example, information indicating the payment target may specify the resource contained in the resource allocation information as long as the payment target is a usage fee for allocated resource. For example, the information indicating the payment target may represent recovery as long as the payment target is, for example, periodical points recovery for the user.

In the case where, for example, what information is stored can be grasped from the content of information in relation to the above-described points management information, the transaction type can be omitted. In the case where the number of points required for service usage and/or resource allocation can be grasped from other piece of information, for example, the case the points management unit 2 preliminarily holds information such as information on the number of points required for one call in each functional unit and information on the number of points required for allocation of each resource, the payment points can be omitted. The number of points before and after the points payments of the payment source and the payee may be included instead of or together with the payment points.

The points management unit 2 may store user information and points information for managing points held by the user and each of the functional units in addition to the above-described information. Note that, in the case where the held points of each entity can be grasped by referring to information other than the points information, the points information can be omitted. In relation to the user information, for example, a privilege for adding a user may be given to a specific management entity. Only the entity may be allowed to add or change the user information. Note that other dedicated entity (e.g., database) may manage the user information while the points management unit 2 does not manage the user information.

The points management unit 2 may store usage fee information indicating a service usage fee (functional unit usage fee) of a functional unit and usage fee (resource usage fee) for a resource in addition to the above-described information. In particular, when the usage fee varies depending on a time or other conditions, the points management unit 2 may store usage fee information containing a usage target (e.g., identifier of a functional unit and the type of a resource) and a usage fee together with a condition.

FIG. 8 shows an example in which the points management information is held in a table format. When the blockchain 41 is used, a block, which contains the content of each record as data (“data” in FIG. 5), is required to be generated and added to the blockchain 41 as needed.

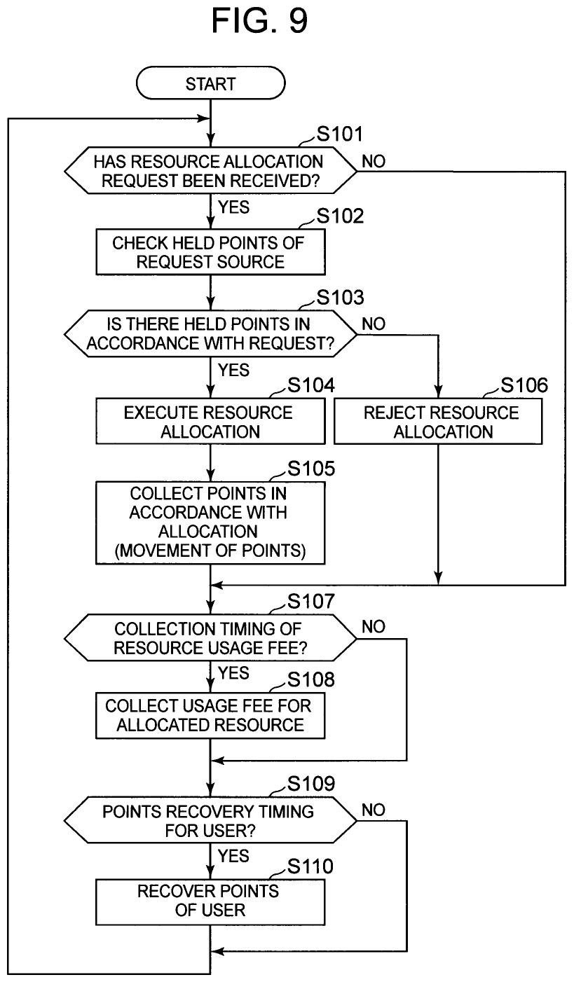

Operation of the exemplary embodiment will now be described. FIG. 9 is a flowchart showing one example of operation of the resource management unit 3 of the exemplary embodiment. In the example in FIG. 9, the allocation control unit 31 first determines whether a resource allocation request has been received (Step S101). When the resource allocation request has been received (Yes in Step S101), the allocation control unit 31 checks held points of a request source (Step S102). When the request source holds points in accordance with the request (Yes in Step S103), the allocation control unit 31 requests the resource allocation unit 32 to execute resource allocation in accordance with the request (Step S104). The allocation control unit 31 collects points from the request source in accordance with the allocation result (Step S105: movement of points).

In contrast, if the request source does not hold points in accordance with the request (No in Step S103), the allocation control unit 31 rejects the request (Step S106).

The allocation control unit 31 determines whether or not the current timing is the collection timing of the resource usage fee (Step S107). Whether or not the current timing is the collection timing of the resource usage fee may be determined on the basis of, for example, whether or not a fixed time period has elapsed since resource allocation or the previous collection.

When the current timing is the collection timing (Yes in Step S107), the allocation control unit 31 collects a usage fee for the allocated resource from the allocation destination entity (Step S108: movement of points). When the current timing is not the collection timing (No in Step S107), the allocation control unit 31 proceeds to Step S109 as it is.

The allocation control unit 31 determines whether or not the current timing is the points recovery timing for the user in Step S109. Whether or not the current timing is the points recovery timing for the user may be determined on the basis of, for example, whether or not a fixed time period has elapsed since service participation of the user or the previous recovery.

When the current timing is the recovery timing (Yes in Step S109), the allocation control unit 31 recovers the points of the user to a predetermined number or a predetermined upper limit (Step S110). When the current timing is not the recovery timing (No in Step S109), the allocation control unit 31 finishes the processing as it is. Note that a processing unit other than the allocation control unit 31 may perform the operations in Steps S109 and S110.

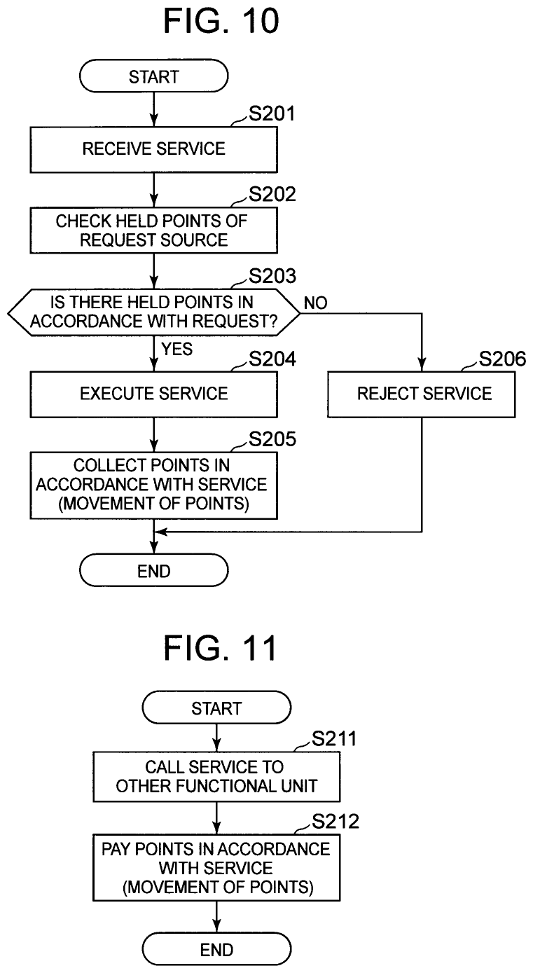

FIG. 10 is a flowchart showing an operation example of the functional unit 1 whose service has been called. In the example in FIG. 10, the service providing unit 11 of the functional unit 1 first receives service (Step S201). The request source of the service is, for example, a user terminal registered in the system or a functional unit called by the terminal.

When the service providing unit 11 receives the service, the points recording unit 12 first checks held points of the request source (Step S202). When the request source holds points corresponding to the request (Yes in Step S203), the service providing unit 11 executes the requested service (Step S204). Accompanying the execution of the service, the points recording unit 12 collects the points from the request source (Step S205: movement of points). This causes the points to move from an entity of the service requesting source to an entity on the service providing side.

Note that the service providing unit 11 can provide service while collecting points at the time of service call. At this time, if failing to provide the service, the service providing unit 11 may pay points to the entity of the request source. The points to be paid may be the same amount as the points collected at the time of the call, or may be a predetermined fixed value. The number of points to be paid if service fails to be provided may be specified at the time of service request.

In contrast, if the request source does not hold points corresponding to the request (No in Step S203), the service providing unit 11 rejects the request (Step S206).

FIG. 11 is a flowchart showing an operation example of an entity on the service calling side. In the example in FIG. 11, an entity first calls service of other functional unit 1 (Step S211). When the service is provided, points are paid in accordance with the service (Step S212: movement of points). Note that the operation in Step S212 corresponds to the operation in Step S205 in FIG. 10.

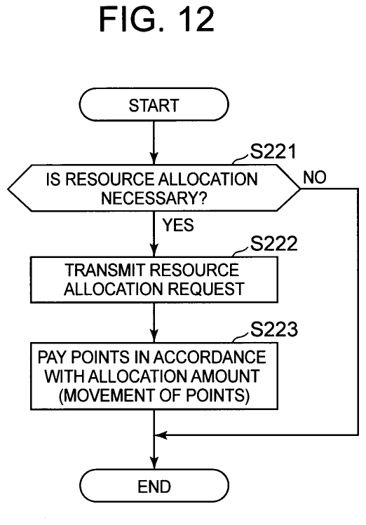

FIG. 12 is a flowchart showing an operation example in the case where a certain functional unit 1 requests allocation of a new resource. In the example in FIG. 12, the service providing unit 11 of the functional unit 1 first determines whether or not resource allocation is necessary (Step S221). When determining that the resource allocation is necessary (Yes in Step S221), the service providing unit 11 transmits a resource allocation request to the resource management unit 3 (Step S222).

When the resource allocation is completed, points are paid in accordance with the allocated resource (Step S222: movement of points). Note that the operation in Step S222 corresponds to the operation in Step S105 in FIG. 9.

Note that, in each of the above-described examples, the held points may be checked by referring to information held by the points management unit 2 (the blockchain 41 in the example). The points may be moved and recovered by issuing a transaction containing information on, for example, a target and moved points, and causing the blockchain 41 to record the movement and recovery. At this time, the transaction is received by any one of the ledger management nodes 42 of the ledger management system 4. A block containing information on the transaction is added to the blockchain 41 through predetermined consensus processing.

In the above-described exemplary embodiment, a resource usage fee may be determined on the basis of resource usage status in the system. For example, the less the remaining amount of an allocatable resource is, the higher the usage fee may be set. In this way, a resource can be preferentially allocated to a functional unit that holds many points, that is, a functional unit that is used more frequently. At this time, the points management unit 2 may hold information indicating the remaining amount of a resource and information indicating a usage fee.

The functional unit 1 may voluntarily release (return) a resource. At this time, points may be returned, but not required to be returned. Even if the points are not returned, the functional unit 1 can be free of payment of subsequent periodic usage fees by releasing the resource. When releasing the resource, each of the functional units 1 is required to issue a transaction indicating the effect, as in the case of resource allocation.

Service usage fee in each of the functional units 1 may be determined on the basis of the service congestion state. For example, the usage fee may be set higher for service that receives many calls at the same time. This enables service to be preferentially provided to an entity that holds many points, thereby further enhancing defense against, for example, a DoS attack. At this time, the points management unit 2 may hold information indicating the service usage status and information indicating a service usage fee.

For example, the service usage fee can be set for each data center, to which the functional unit 1 of the provider belongs, or for each instance. For example, the service usage fee can be set higher for an instance that provides service to many users or other functional units. This promotes usage of an instance that costs a lower service usage fee, and a load can be distributed.

The usage fee may be changed depending on the payment timing of the service usage fee. For example, the service usage fee may be changed depending on whether prepayment or deferred payment, or on distribution of the prepayment or deferred payment. The risk that occurs when service fails to be provided can be shared between the caller side and the callee side by separating payments on the basis of the prepayment and the deferred payment. Not only the service usage fee but service priority can be changed.

Penalties such as the predetermined number of service rejections and lowering priority can be imposed on an entity that did not paid the service usage fee or the resource usage fee in the past.

As described above, according to the exemplary embodiment, the service of each functional unit needs to be used by a user or other functional units so as to receive a resource. Consequently, a dishonest resource allocation request can be inhibited. The dishonest resource allocation request includes a resource allocation request, in a fictitious busy state, not accompanying the reality of service provision. According to the exemplary embodiment, the points that each user can use per time are limited, so that a busy state caused by, for example, malicious calls, such as a DoS attack, on a user side and an inappropriate resource allocation caused by the busy state can also be inhibited. As a result, inappropriate resource allocation is reduced, and a resource can be preferentially allocated to a functional unit that actually provide service.

According to the exemplary embodiment, even when individual functional units independently request a resource as in the MSA using a microservice having weak coupling, resource allocation that matches the demand is achieved by market principles working through the points.

For example, an initial value of the service usage fee of the functional unit 1 is preliminarily determined, and then is changed in accordance with the demand. This causes a market principle to work, and a resource is appropriately allocated. In the market principle, the functional unit 1 having more points (higher demand) can preferentially use other services at the time of congestion. Processing can be set to flow to an instance with a normal price also in the functional unit 1 that provides the same function by, for example, setting the service usage fee for each data center or each instance. In this case as well, too inexpensive setting can be made so as not to maintain a resource. A market principle of excluding an instance that sets an abnormal price such as a rip-off and dumping works, and a resource is appropriately allocated.

For example, an initial value of the resource usage fee is preliminarily determined, and then the initial value may be changed in accordance with the demand. This causes a market principle to work, and a resource is appropriately allocated. In the market principle, the functional unit 1 having more points (higher demand) can preferentially use a resource at the time of congestion. For example, the resource usage fee may be changed in accordance with the resource usage amount (allocation amount) in the functional unit 1 of the allocation destination. In that way, one functional unit can be prevented from having too many resources.

A user can use service only for distributed points. As a result, loads can advantageously be distributed by using a service with high degree of usage necessity or inexpensive service in another example and effect of the market principle to work in the system.

Each of the functional units 1 can reduce requesters by increasing the service usage fee, for example, when the service demand is large with respect to the allocated resource amount. Many demands lead to the increase in points. A new resource can be acquired for increased points. In contrast, when the service demand is small with respect to the allocated resource amount, the resource can be returned to reduce the points payment. In this way, an appropriate amount of resources can be held in accordance with a demand.

According to the exemplary embodiment, the resource server (more specifically, the resource management unit 3) can set a lower usage fee when the resource server has a large remaining amount of resource, and can set a high usage fee when the resource server has a small remaining amount of resource. In such a way, a resource may be preferentially allocated to a functional unit having a higher degree of necessity (being accessed from many users and having many points). Varying the usage fee in this way enables a resource server having many remaining resources to be preferentially and easily used.

As another effect of the above-described behavior at the time of congestion, a functional unit that falls into a DoS state and is difficult to give service cannot provide service even if there is a service demand, and thus the functional unit cannot pay the resource usage fee and cannot maintain the resource. When a resource is biased to a service on the front-end side, the bias can be balanced by using the effect.

When a balance of supply and demand of service is changed owing to, for example, division of a network, it is expected that a functional unit having reduced demand releases a resource and a functional unit having increased demand secures a new resource. According to the exemplary embodiment, a resource allocation amount can be optimized in accordance with a demand.

In the exemplary embodiment, a resource can be allocated simply by checking held points of each entity. This eliminates the need for one management entity to monitor the entire system and manage, for example, a resource necessary for service provision. That is, quantifying the usage status of each functional unit through points enables the functional unit 1 and the resource management unit 3 to operate fully dispersively to acquire and release a resource, whereby independence of each of the functional unit 1 and the resource management unit 3 can be maintained high. Even when the independence of each entity is enhanced in such a way, excessive resource allocation can be inhibited by limiting the total number of points that each user can hold.

For example, even if a malicious user repeats a call to a specific functional unit for the purpose of a DoS attack, equal to or more than a certain amount of calls can be prevented since points are depleted. Even if a plurality of users colludes with each other, the influence of the DoS attack can be reduced by increasing the service usage fee of the functional unit in response to high demand.

Similarly, for example, even if a malicious functional unit makes a DoS attack on other functional unit or excessively requests resources that are not used, equal to or more than a certain amount of attacks and requests can be prevented since points are depleted.

In relation to recording to a blockchain, when processing proceeds with “0 confirmation” and a mismatch occurs, a penalty can be given later. In the “0 confirmation”, information is believed without waiting for a block to be added to the tail end.

For example, even if an entity carries out a dishonest act such as using a dishonest functional unit such as n-fold payment and declaring non-use despite use, a penalty such as rejecting subsequent service and resource allocation can be imposed by checking whether there is dishonesty by using a blockchain having high falsification resistance.

### Second Exemplary Embodiment

A second exemplary embodiment will now be described. In the exemplary embodiment, each of functional units 1 is provided with the management function of the blockchain 41 assuming that the ledger management system 4 is used as a points management unit 2.

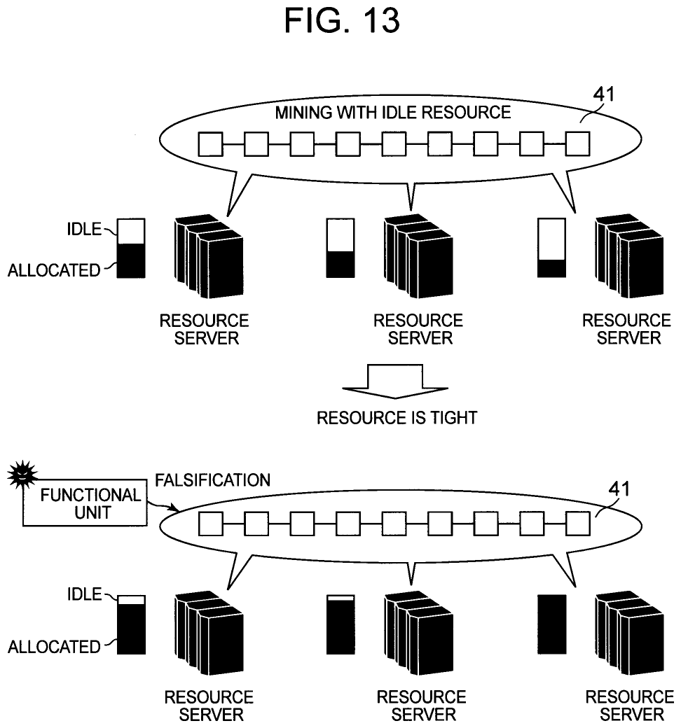

FIG. 13 is an explanatory diagram for explaining a problem when only a resource server performs management (more specifically, PoW) of a blockchain by using an idle resource. As shown in FIG. 13, when only a resource server manages a blockchain with an idle resource, the resource server has difficulty in managing the blockchain in a situation of a tight CPU resource. This is because the resources, which can be used for PoW, necessary for adding a block to the blockchain are insufficient, the computation amount necessary for preventing falsification cannot be secured, and the security of the blockchain is lowered.

In the exemplary embodiment, each of the functional units 1 is also provided with a function of mining, that is, a function of performing PoW. When mining is successful, points are given as an incentive. At this time, an incentive fee or a resource usage fee may be determined so that a specific functional unit does not hold too much computation amount.

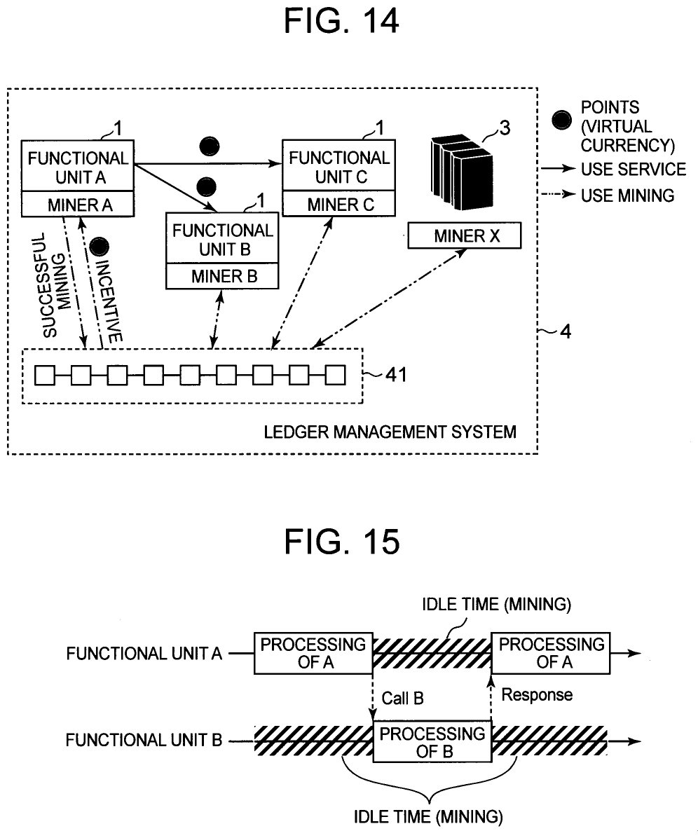

FIGS. 14 and 15 are explanatory diagrams outlining the exemplary embodiment. As shown in FIG. 14, each of the functional units 1 also operates as a miner that further performs mining in the exemplary embodiment. For example, a “functional unit A” also operates as a “miner A”. For example, as shown in FIG. 15, each of the functional units 1 participates in mining in an idle time using the allocated resource. Here, examples of the idle time include time obtained when the amount of requests (service requests) from other entities has decreased and time for waiting for a response from other functional unit.

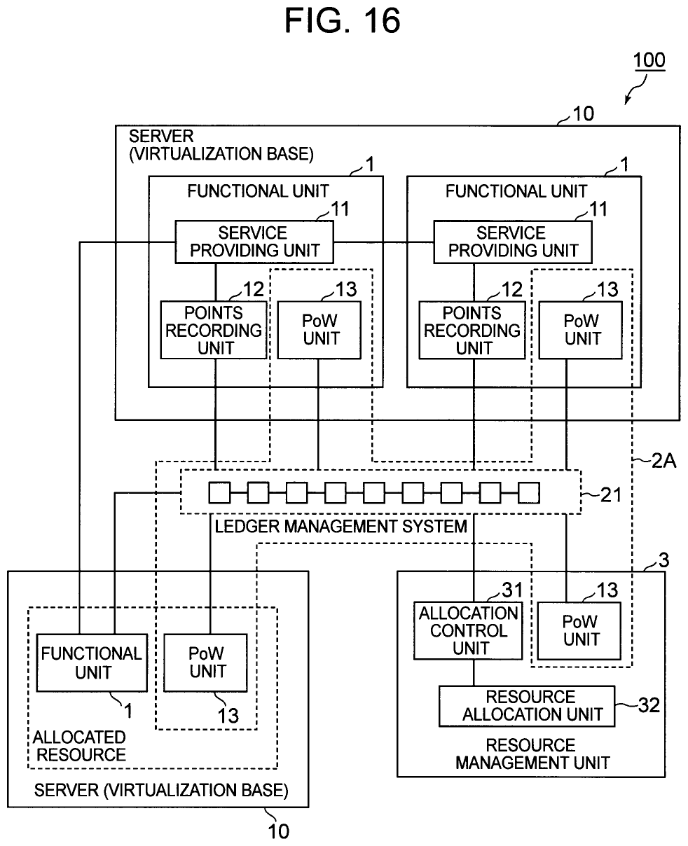

FIG. 16 is a block diagram showing a configuration example of a resource management system of the exemplary embodiment. As shown in FIG. 16, a PoW unit 13 is added to a server 10 (e.g., virtualization base) in the exemplary embodiment. The PoW unit 13 implements each function of a ledger management node 42 or part of the function (e.g., the block generation unit 422 and the information storage unit 424 in FIG. 7). The server 10 serves as a functional unit or a container for operating the functional unit.

For example, the PoW unit 13 performs predetermined consensus processing on a block generated by the PoW unit 13 itself or a block generated by other ledger management node 42. When the processing is successful, the PoW unit 13 adds the block to the blockchain 41.

In the example in FIG. 16, a functional unit 1 is provided in the server (virtualization base) 10. At this time, the server 10 may implement two or more functional units 1. The PoW unit 13 is provided in such a server 10 or the functional unit 1 that operates on the server 10. The PoW unit 13 performs at least predetermined consensus processing with a resource allocated to the functional unit 1. Note that, although FIG. 16 shows one blockchain 41, the blockchain 41 is actually held in each of the ledger management nodes 42. At this time, the ledger management node 42 may include the functional unit 1 including the PoW unit 13, and the server 10.

Note that the incentive fee for successful mining is preferably determined as follows. That is, the incentive fee is preferably determined on the basis of a target value of mining and a resource usage fee.

In one example, the following expression (1) is preferably satisfied.

Vᵢ*P(T,C)<Vᵣ (1)

where T represents a target value, C represents the number of computation (computation amount spent on mining) of unidirectional function capable of being performed per unit time, Nₘₐₓ represents the maximum value of nonce, P (T, C)=1−(1−T/Nₘₐₓ) represents mining success probability per unit time, Vᵣ represents a resource usage fee per unit time, and Vᵢ represents an incentive.

Here, the computation amount C, in the above-described expression (1), spent for mining may be computed by using only an allocated resource amount, and can be computed including service usage status. In another example, the more allocated resource there is, the smaller the incentive may simply be. Note that the resource usage fee per unit time can be determined on the basis of the target value of mining and the incentive fee for successful mining.

In any case, the incentive fee or the resource usage fee per unit time is only required to be set so as to be in a deficit if only mining continues to be performed. This inhibits an attempt of the malicious functional unit 1 or server 10 to falsify the blockchain 41 by spending all resources, which has been allocated to the functional unit 1 or server 10 itself or a functional unit that operates on the functional unit 1 or server 10 itself, for mining.

As described above, according to the exemplary embodiment, a computation amount necessary for preventing falsification from a malicious node is secured by giving an incentive to engage each functional unit 1 in mining operation or motivating each functional unit 1 to lend a resource for the mining operation. As a result, decrease in security of a blockchain can be prevented.

According to the exemplary embodiment, the functional unit 1 having low service demand with respect to the allocated resource amount can temporarily participate in mining and obtain points. Variation of the resource amount, with respect to that of the demand, in the functional unit 1 can thus be moderated. Note that other points are similar to those in the first exemplary embodiment.

### Third Exemplary Embodiment

In the exemplary embodiment, a user has priority, and priority control in service provision in accordance with the priority is performed.

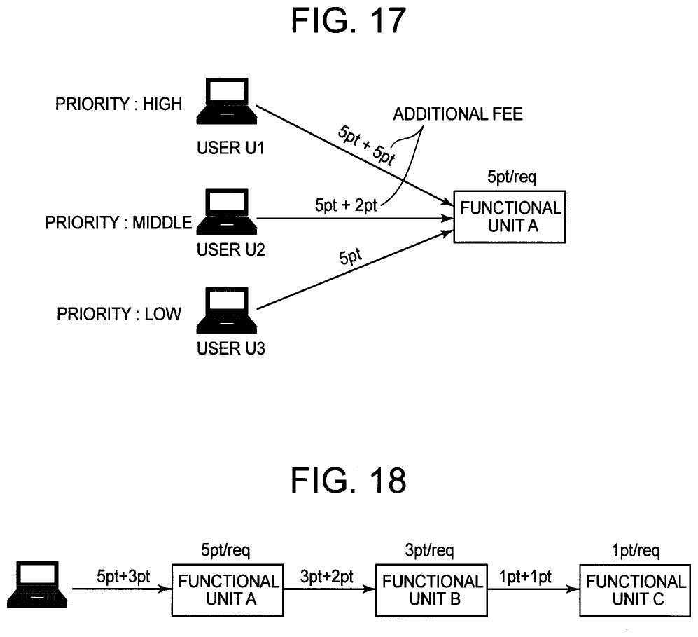

FIG. 17 is an explanatory diagram outlining the exemplary embodiment. In the example in FIG. 17, each user can pay an additional fee (additional points) when using other functional unit. A request receiving side more preferentially processes a request with larger additional fee.

In the exemplary embodiment, priority is set for a user. An upper limit of the additional fee is then set for each priority. The user can freely set an additional fee within a range that falls below the upper limit in accordance with the priority set for the user. The functional unit that has received the request preferentially provides service in accordance with the additional fee.

The upper limit of the additional fee for each priority may be determined as a proportion to a service usage fee of the functional unit 1 of a callee, or may be uniformly determined to all functional units 1 regardless of the functional unit 1 of the callee.

Information on priority and information on the upper limit of an additional fee for each priority may be stored, for example, in the blockchain 41, or may be shared by using, for example, a management server and a database.

Note that a method of priority processing in each of the functional units 1 of the callee is not particularly limited. In one example, the functional unit 1 may change processing order in accordance with an additional fee. For example, the functional unit 1 may change the standard of determining whether service can be provided at the time of congestion in accordance with an additional fee, as “when an additional fee is equal to or more than xx, service is provided even when a resource usage rate is equal to or more than yy”. For example, the functional unit 1 may cancel provision of service with a low additional fee among currently provided services and secure a resource for service with a high additional fee in accordance with an additional fee. At this time, the functional unit 1 may pay compensation points at the time of service failure for the canceled service. When the compensation points to be paid at the time when the currently provided service fails is equal to or less than the additional fee of newly received service, the functional unit 1 may determine that the currently provided service is canceled.

In the exemplary embodiment, when the functional unit 1 calls other functional unit 1 to perform service for which an additional fee has been paid, the former functional unit 1 can pay an additional fee to the functional unit 1 of the callee within the range of the additional fee paid for the service (see FIG. 18). When failing to provide service, the functional unit 1 may refund points equivalent to or more than the additional fee. This can inhibit a behavior of providing service with normal priority while receiving an additional fee in the functional unit 1.

The number of points to be periodically recovered may be increased for a user having higher priority. Note that other points may be similar to those in the first and second exemplary embodiments.

According to the exemplary embodiment, a user can have priority, and service can be preferentially provided to a user who has high priority and desires priority control.

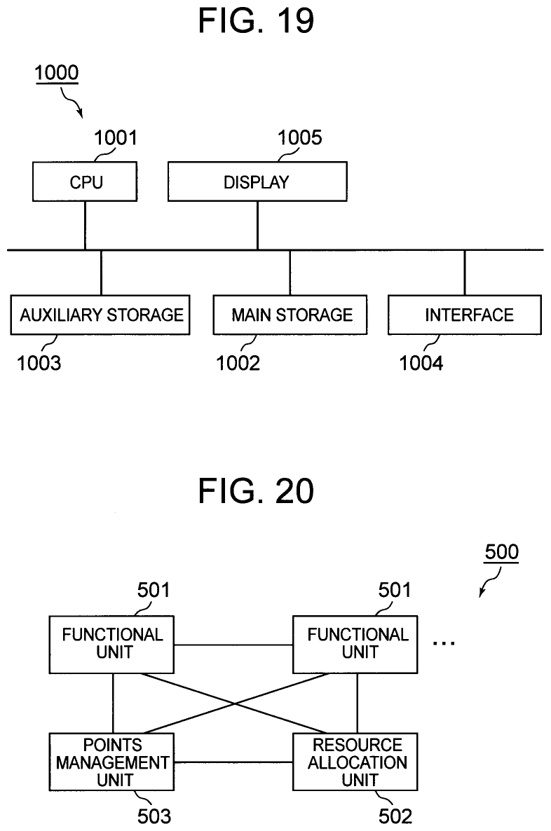

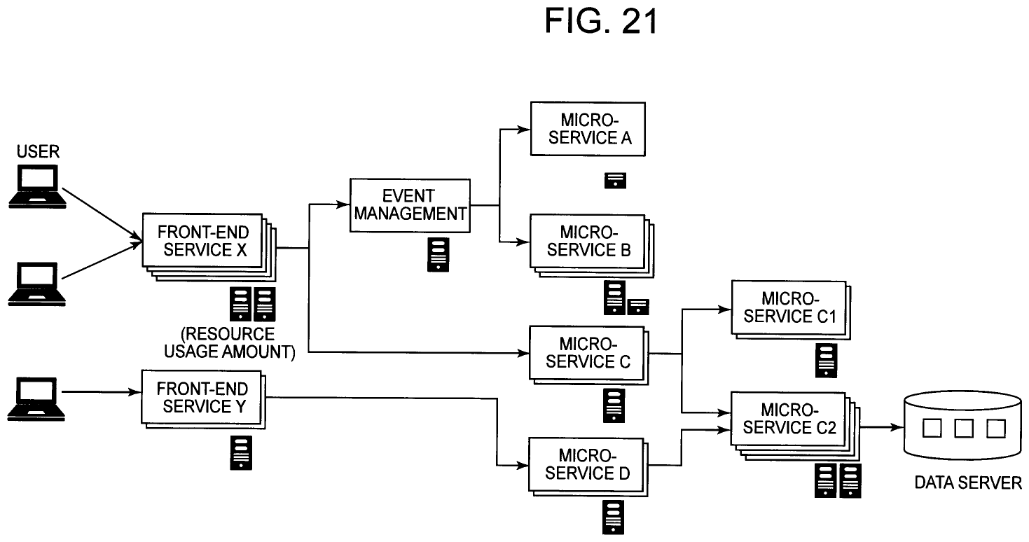

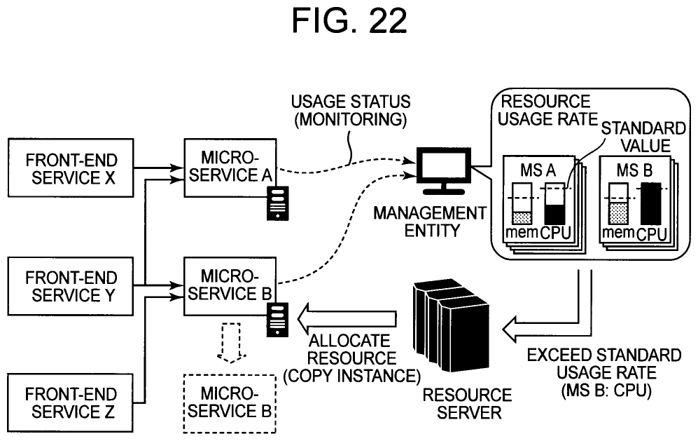

A configuration example of a computer according to the exemplary embodiment of the invention will now be described. FIG. 19 is a schematic block diagram showing the configuration example of a computer according to the exemplary embodiment of the invention. A computer 1000 includes a CPU 1001, a main storage 1002, an auxiliary storage 1003, an interface 1004, a display 1005, and an input device 1006.

For example, components of a resource management system such as the functional unit 1, the resource management unit 3, and the ledger management node 42 described above may be implemented in the computer 1000. In that case, the operation of each device may be stored in the auxiliary storage 1003 in the form of a program. The CPU 1001 reads the program from the auxiliary storage 1003, decompresses the program in the main storage 1002, and performs predetermined processing in the above-described exemplary embodiment in accordance with the program.

The auxiliary storage 1003 is an example of a non-transitory tangible media. Other examples of the non-transitory tangible media include magnetic disks, magneto-optical disks, CD-ROMs, DVD-ROMs, and semiconductor memories, which are connected via the interface 1004. When the program is delivered to the computer 1000 over a communication line, the computer 1000, which received the delivery, may decompress the program in the main storage 1002 and perform predetermined processing in the above-described exemplary embodiment.

The program may be used for performing a part of predetermined processing in each exemplary embodiment. The program may be a difference program for performing the predetermined processing in the above-described exemplary embodiment in combination with another program already stored in the auxiliary storage 1003.

The interface 1004 transmits and receives information to and from another device. The display 1005 presents information to a user. The input device 1006 receives input of information from the user.

Some elements of the computer 1000 can be omitted depending on the processing content in the exemplary embodiment. For example, when a device does not present information to the user, the display 1005 can be omitted.

Part or all of each component of each device is implemented by, for example, a general-purpose or dedicated circuitry, a processor, or a combination thereof. These may be configured by a single chip, or may be configured by a plurality of chips connected via a bus. Part or all of each component of each device may be implemented in combination of, for example, the above-described circuitry and a program.

When the part or all of each component of each device is implemented by, for example, a plurality of information processing device and circuitry, the plurality of information processing device and circuitry may be disposed centrally or dispersively. For example, the information processing device, circuitry, and the like may be implemented in a form in which, for example, a client-and-server system and a cloud computing system, each component are connected via a communication network.

A resource management system of the invention will now be outlined. FIG. 20 is a block diagram outlining a resource management system of the invention. A resource management system 500 in FIG. 20 includes one or more functional units 501, a resource allocation unit 502, and a points management unit 503.

Each of the functional units 501 (e.g., functional units 1) provides a predetermined function as a service. At this time, each of the functional units 501 provides the service for exchanging for each of the points held by the requesting user or other functional unit 501.

The resource allocation unit 502 (e.g., resource management unit 3) allocates a resource for executing a service, to each of the functional units 501. At this time, the resource allocation unit 502 allocates the resource by reducing each of the points held by the functional unit 501 that is the allocation destination.

The points management unit 503 (e.g., points management unit 2), for each user and each of the functional units 501, manages the number of points held, said points being virtual currency required for receiving a service.

This configuration enables resource allocation that matches the reality of service provision.

The resource management system may further include a points recovering unit and a points collecting unit. The points recovering unit recovers points of a user at a fixed interval. The points collecting unit collects points from a functional unit that is the allocation destination at a fixed interval for an allocated resource.

The points management unit may manage the number of points held by the each user and each of the functional units by using a blockchain to which a block is added through predetermined consensus processing.

At this time, a functional unit or a server operating the functional unit may perform the predetermined consensus processing for adding a block to a blockchain by using the resource allocated to the functional unit.

At this time, points may be paid to the functional unit as an incentive when the predetermined consensus processing is successful, and an incentive fee may be determined on the basis of a target value used for the predetermined consensus processing and a resource usage fee per unit time, or the resource usage fee per unit time may be determined on the basis of a target value used for the predetermined consensus processing and an incentive fee.

In the above-described resource management system, a resource usage fee per unit time may vary in accordance with the remaining number of resources in the resource allocation unit that manages a resource, or a service usage fee of the functional unit may vary in accordance with a service congestion state in the functional unit.

In the above-described resource management system, priority is preliminarily determined for each user. When requesting service from a functional unit, the user is allowed to give additional points whose upper limit is determined in accordance with the priority. The functional unit may preferentially process the request depending on the additional points.

The points management unit may include an information holding unit and a points updating unit. The information holding unit holds points management information, with which points held for each user and each of functional units can be grasped. The points updating unit may move or increase/decrease points by updating or editing the points management information held by the information holding unit in response to a request from the user, the functional unit, or the resource allocation unit. The information holding unit may be implemented in one or more nodes that manage a blockchain to which a block is added through predetermined consensus processing. The information holding unit may store a chain block, to which a block containing information indicating movement or increase/decrease of the points, is sequentially added. The points updating unit may be implemented in one or more nodes. The points updating unit may perform processing of adding the block containing information indicating movement or increase/decrease of the points to the blockchain.

Although the invention has been described above with reference to the exemplary embodiments and the examples, the invention is not limited to the above-described exemplary embodiments and examples. Various modification that can be understood by those skilled in the art can be added to the configuration and details of the invention within the scope of the invention.

### INDUSTRIAL APPLICABILITY

The invention can be preferably applied to an application for resiliently providing service.

### REFERENCE SIGNS LIST

100 Resource management system
1 Functional unit
10 Server
11 Service providing unit
12 Points recording unit
13 PoW unit
2 Points management unit
21 Information holding unit
22 Points updating unit
4 Ledger management system
41 Blockchain
42 Ledger management node
421 Data reception unit
422 Block generation unit
423 Block sharing unit
424 Information storage unit
425 Block verification unit
426 Data output unit
3 Resource management unit
31 Allocation control unit
32 Resource allocation unit
1000 Computer
1001 CPU
1002 Main storage
1003 Auxiliary storage
1004 Interface
1005 Display
1006 Input device
500 Resource management system
501 Functional unit
502 Resource allocation unit
503 Points management unit

1. A resource management system comprising:
one or more functional units which provide a predetermined function as a service;
a resource allocation unit which allocates a resource for executing a service, to each of the functional units; and
a points management unit which, for each user and each of the functional units, manages the number of points held, said points being virtual currency required for receiving a service,
wherein each of the functional units provides a service for exchanging for each of the points held by the requesting user or other functional unit, and
the resource allocation unit allocates the resource by reducing each of the points held by a functional unit that is the allocation destination.

2. The resource management system according to claim 1, further comprising:
a points recovering unit which recovers points of the user at a fixed interval, and
a points collecting unit which collects points from a functional unit that is the allocation destination at a fixed interval for an allocated resource.

3. The resource management system according to claim 1,
wherein the points management unit manages the number of points held by the each user and each of the functional units by using a blockchain to which a block is added through predetermined consensus processing.

4. The resource management system according to claim 3,
wherein the functional unit or a server operating the functional unit performs the predetermined consensus processing for adding a block to the blockchain by using a resource allocated to the functional unit.

5. The resource management system according to claim 4,
wherein points are paid to the functional unit as an incentive when the predetermined consensus processing is successful, and
an incentive fee is determined on the basis of a target value used for the predetermined consensus processing and a resource usage fee per unit time, or the resource usage fee per unit time is determined on the basis of a target value used for the predetermined consensus processing and an incentive fee.

6. The resource management system according to claim 1,
wherein a resource usage fee per unit time varies in accordance with a remaining number of resources in the resource allocation unit that manages the resource, or a service usage fee of the functional unit varies in accordance with a service congestion state in the functional unit.

7. The resource management system according to claim 1,
wherein priority is preliminarily determined for each user,
when requesting service from the functional unit, the user is allowed to give additional points whose upper limit is determined in accordance with the priority, and
the functional unit preferentially processes a request depending on the additional points.

8. A management device comprising:
an information holding unit which holds points management information, with which the number of points held, said points being virtual currency required for receiving a service is capable of being grasped, for each user and each of one or more functional units that provide a predetermined function as a service; and
a points updating unit which performs processing of moving each of the points from the requesting user or other functional unit to a functional unit of a request destination in accordance with provision of the service in each of the functional units and processing of reducing each of the points held by a functional unit that is the allocation destination in accordance with allocation of the resource to the functional unit by updating or editing the points management information held by the information holding unit.

9. A resource management method in a resource management system including: one or more functional units which provide a predetermined function as a service; and a resource allocation unit which allocates a resource for executing a service, to each of the functional units,
wherein one or more information processing devices:
for each user and each of the functional units, manage the number of points held, said points being virtual currency required for receiving a service;
move each of the points from the requesting user or other functional unit to a functional unit of a request destination in accordance with provision of the service in the functional unit; and
reduce each of the points held by a functional unit that is the allocation destination in accordance with allocation of the resource to the functional unit.

10. (canceled)

11. The resource management system according to claim 2,
wherein the points management unit manages the number of points held by the each user and each of the functional units by using a blockchain to which a block is added through predetermined consensus processing.

12. The resource management system according to claim 11,
wherein the functional unit or a server operating the functional unit performs the predetermined consensus processing for adding a block to the blockchain by using a resource allocated to the functional unit.

13. The resource management system according to claim 12,
wherein points are paid to the functional unit as an incentive when the predetermined consensus processing is successful, and
an incentive fee is determined on the basis of a target value used for the predetermined consensus processing and a resource usage fee per unit time, or the resource usage fee per unit time is determined on the basis of a target value used for the predetermined consensus processing and an incentive fee.

14. The resource management system according to claim 2,
wherein a resource usage fee per unit time varies in accordance with a remaining number of resources in the resource allocation unit that manages the resource, or a service usage fee of the functional unit varies in accordance with a service congestion state in the functional unit.

15. The resource management system according to claim 3,
wherein a resource usage fee per unit time varies in accordance with a remaining number of resources in the resource allocation unit that manages the resource, or a service usage fee of the functional unit varies in accordance with a service congestion state in the functional unit.

16. The resource management system according to claim 4,
wherein a resource usage fee per unit time varies in accordance with a remaining number of resources in the resource allocation unit that manages the resource, or a service usage fee of the functional unit varies in accordance with a service congestion state in the functional unit.

17. The resource management system according to claim 5,
wherein a resource usage fee per unit time varies in accordance with a remaining number of resources in the resource allocation unit that manages the resource, or a service usage fee of the functional unit varies in accordance with a service congestion state in the functional unit.

18. The resource management system according to claim 11,
wherein a resource usage fee per unit time varies in accordance with a remaining number of resources in the resource allocation unit that manages the resource, or a service usage fee of the functional unit varies in accordance with a service congestion state in the functional unit.

19. The resource management system according to claim 12,
wherein a resource usage fee per unit time varies in accordance with a remaining number of resources in the resource allocation unit that manages the resource, or a service usage fee of the functional unit varies in accordance with a service congestion state in the functional unit.

20. The resource management system according to claim 13,
wherein a resource usage fee per unit time varies in accordance with a remaining number of resources in the resource allocation unit that manages the resource, or a service usage fee of the functional unit varies in accordance with a service congestion state in the functional unit.

21. The resource management system according to claim 2,
wherein priority is preliminarily determined for each user,
when requesting service from the functional unit, the user is allowed to give additional points whose upper limit is determined in accordance with the priority, and
the functional unit preferentially processes a request depending on the additional points.
